(19) United States
(12) Patent Application Publication
(10) Pub. No.: US 2013/0087415 A1
(43) Pub. Date: Apr. 11, 2013

(54) SPRING BRAKE

(71) Applicant: Chia-Ching Hsieh, Taichung (TW)

(72) Inventor: Chia-Ching Hsieh, Taichung (TW)

(73) Assignee: NIEN MADE ENTERPRISE CO., LTD., Taichung (TW)

(21) Appl. No.: 13/480,929

(22) Filed: May 25, 2012

(30) Foreign Application Priority Data
Oct. 9, 2011 (CN) 201120379261.0

(51) Int. Cl. F03G 1/06

(52) U.S. Cl. 185/37

(57) ABSTRACT

A spring brake includes a base, on which a first reel and a second reel are pivoted. A mainspring has opposite ends connected to the first reel and the second reel. A stop device has a pressing portion to press the mainspring when the mainspring is wound on the second reel. Therefore, the pressing portion of the stop device will touch the mainspring when the mainspring is wound on the second reel and give the mainspring a resistance to offset the recovery force of the mainspring.

### BACKGROUND OF THE INVENTION

1. Field of the Invention

The present invention relates generally to a spring, and more particularly to a spring brake.

2. Description of the Related Art

In a conventional window covering, it provides a spring box to receive cords, which connects to the slats, therein. U.S. patent application 2007/0261798 taught a cordless shade, in which a shaft is provided between a base and a spring box. The base has a barrel for the wire to be wound thereon. The spring box has a mainspring whose opposite ends respectively are fixed to a first reel and a second reel. The mainspring will be wound on the first reel when the shade is folded, and wound on the second reel when the shade is unfolded. The shaft has its opposite ends to connect to the barrel and a bevel gear to transmit a spring force of the mainspring and change the direction of the spring force to turn the barrel for winding the wire.

When the shade is totally unfolded and the mainspring is wound on the second reel, the shade is unstable because the recovery force of the mainspring will force the mainspring going back to the first reel. The shade will therefore not reach the totally unfolded position. If this problem can be fixed, it may increase the quality.

### SUMMARY OF THE INVENTION

The primary objective of the present invention is to provide a spring brake, which may provide the spring box a stable spring force.

According to the objective of the present invention, a spring brake includes a base, on which a first reel and a second reel are pivoted. A mainspring has opposite ends connected to the first reel and the second reel. A stop device has a pressing portion to press the mainspring when the mainspring is wound on the second reel.

In an embodiment, the spring brake further includes a driving device with opposite ends against the stop device and the base.

In an embodiment, the base has a bore on a lateral wall, the stop device has a rod passing through the bore, the pressing portion is provided on an end of the rod, and a stop member is provided on the other end of the rod, and the driving device is a spring fitted to the rod to urge the lateral wall of the base and the pressing portion.

In an embodiment, the stop member has a threaded hole, and the rod of the stop device has a threaded section to be screwed into the threaded hole of the stop member to attach the stop member to an outer side of the lateral wall.

In an embodiment, the stop device is a spring plate projected from the base, and the pressing portion is formed on a free end thereof.

In an embodiment, the spring brake further includes a driving device respectively against the spring plate and the base.

In an embodiment, the spring plate has a post, the base has a post on a lateral wall, and the driving device is a spring with opposite ends respectively fitted to the posts.

Therefore, the pressing portion of the stop device will touch the mainspring when the mainspring is wound on the second reel and give the mainspring a resistance to offset the recovery force of the mainspring.

### BRIEF DESCRIPTION OF THE DRAWINGS

FIG. 1 and FIG. 2 are perspective views of a first preferred embodiment of the present invention;

FIG. 3 is a front view of the first preferred embodiment of the present invention, showing the mainspring wound on the first reel;

FIG. 4 is a front view of the first preferred embodiment of the present invention, showing the mainspring wound on the second reel;

FIG. 5 is a perspective view of a second preferred embodiment of the present invention;

FIG. 6 is a perspective view of a third preferred embodiment of the present invention; and

FIG. 7 is an enlarged view of FIG. 6.

### DETAILED DESCRIPTION OF THE INVENTION

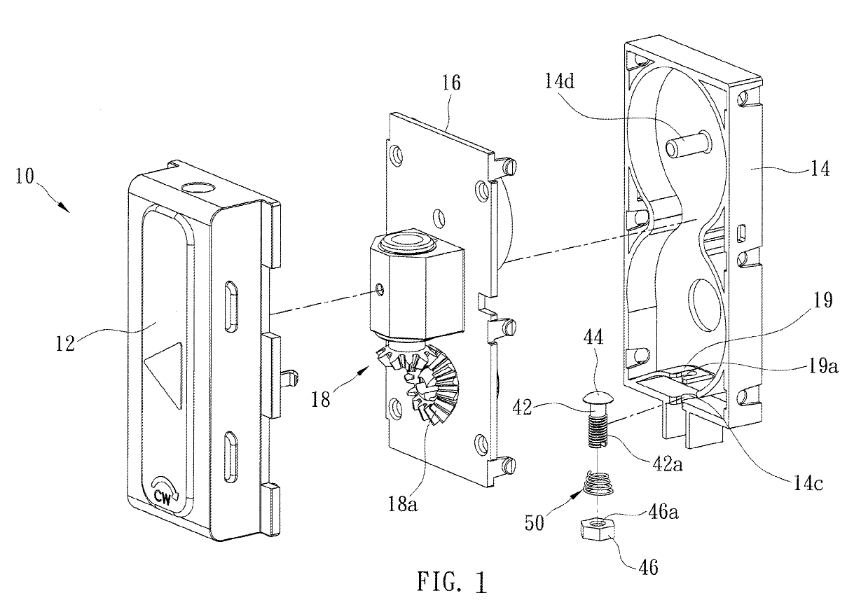

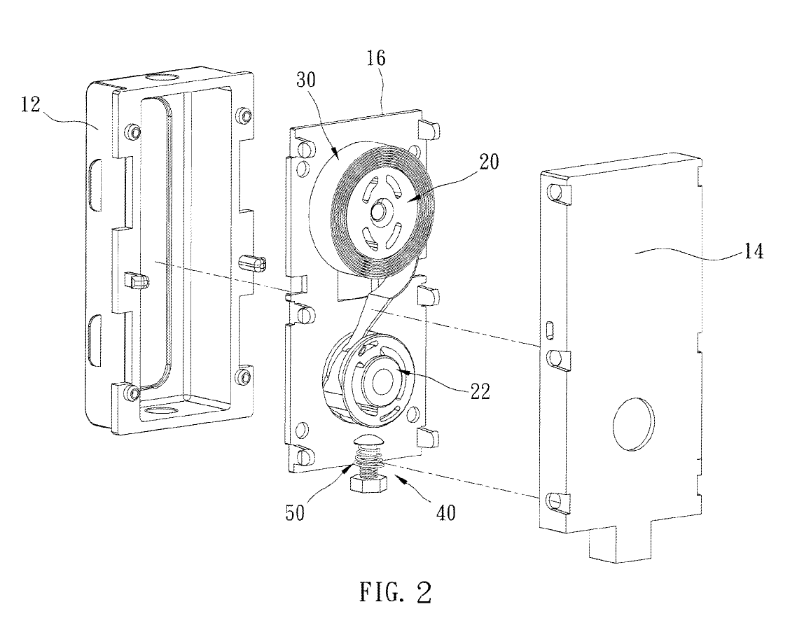

FIG. 1 and FIG. 2 show a spring brake of the first preferred embodiment of the present invention. The spring brake is received in a box 10 and is connected to a barrel (not shown) for winding a wire (not shown). The barrel is a conventional device, so we do not describe its detail here.

The box 10 includes a lid 12, a base 14, and a board 16. The base 14 is a part of the spring brake, in which two rooms 14a, 14b are provided. The board 16 is between the lid 12 and the base 14. A bevel gear set 18 is between the lid 12 and the board 16 to move the barrel. The base 14 has a bore 14c on a lateral wall, and the bore 14c extends to a top edge of the lateral wall. A rib board 19 is projected from an inner side of the base 14, and consequently the rib board 19 is flexible. The rib board 19 has a bore 19a corresponding to the bore 14a of the base 14. In the present embodiment, the bore 19a is open at a lateral edge of the rib board 19, and, however, it may be a closed bore.

The spring brake of the first preferred embodiment includes a first reel 20, a second reel 22, a mainspring 30, a stop device 40, and a driving device 50.

The first reel 20 and the second reel 22 respectively are received in the rooms 14a, 14b of the base 14. The first reel 20 is fitted to a post 14d projected from an interior side of the base 14, and the second reel 22 is connected to a bevel gear 18a of the bevel gear set 18 to simultaneously turn the bevel gear 18a.

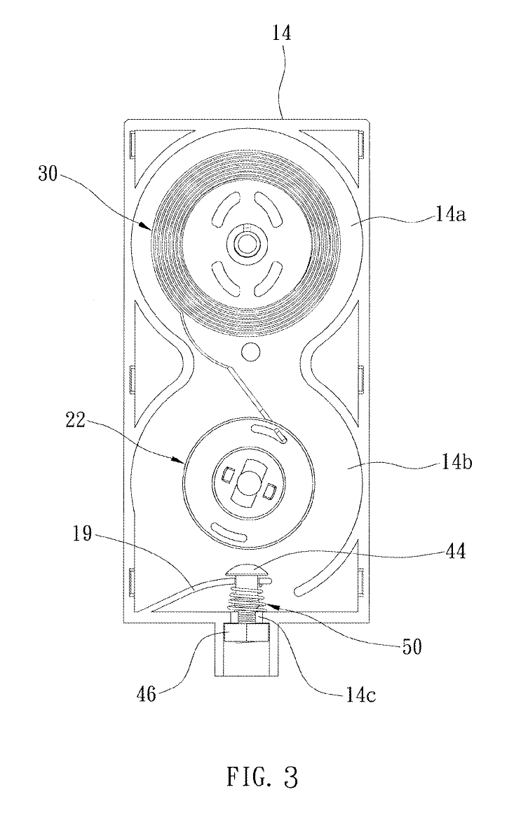

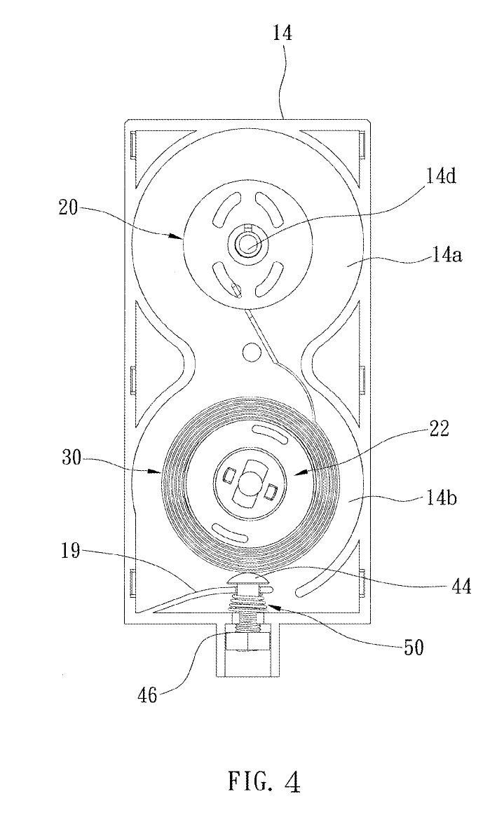

The mainspring 30 has its opposite ends to connect to the first reel 20 and the second reel 22. FIG. 3 shows the mainspring 30 is totally wound on the first reel 20, while a shade (not shown) is totally folded. On the contrary, the mainspring 30 will shift to the second reel 22 as the shade is unfolding to turn the second reel 22 through the bevel gear set 18, and the shade is totally unfolded when the mainspring 30 is totally wound on the second reel 22, as shown in FIG. 4.

The stop device 40 has a rod 42 to pass through the bores 14c and 19a of the base 14 and the rib board 19, and a pressing portion 44 on an end of the rod 42. The pressing portion 44 is beyond the rib board 19 and is bigger than the bore 19a so that the pressing portion 44 is rested on the rib board 19. The rod has a threaded section 42a adjacent to an end opposite to the pressing portion 44 so that the stop device 40 may be screwed into a threaded hole 46a of a stop member 46. The stop device 40 is held by both the lateral wall of the base 14 and the rib board 19 so that the stop device 40 may move smoothly and stably.

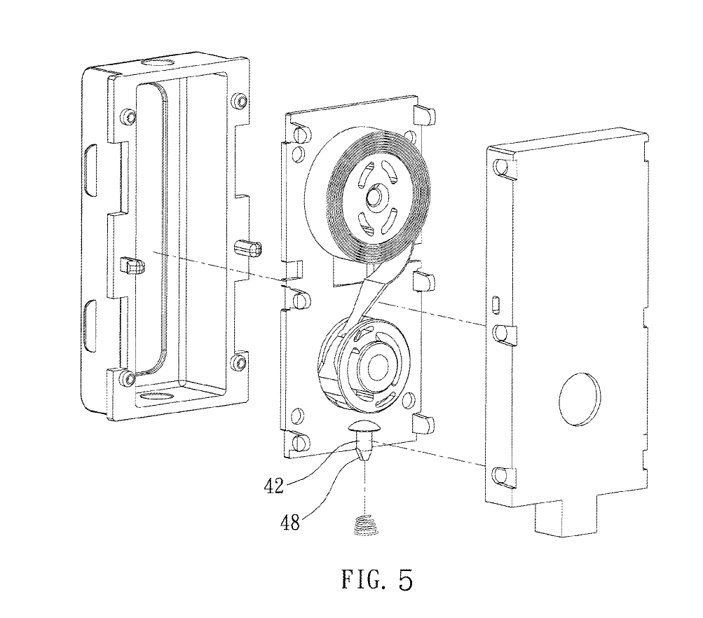

The driving device 50 is a spring in the present embodiment. The spring 50 is fitted to the rod 42 of the stop device 40 and has opposite ends to urge the lateral wall, on which the bore 14c is provided, and the rib board 19 respectively. The stop member 46 touches an outer side of the lateral wall to avoid the stop device 40 from separating from the base 14. FIG. 5 shows another design to avoid the stop device 40 from separating, in which the stop member 48 and the rod 42 are made into a single unit to achieve the same function.

The spring 50 urges the rib board 19, and the rib board 19 urges the pressing portion 44 of the stop device 40 to move the pressing portion 44 toward the second reel 22, and the stop device 40 is stopped by the stop member 46 so that the pressing portion 44 is stopped at a predetermined position and is kept a predetermined distance from the second reel 22 as shown in FIG. 3. As the shade is unfolding, the mainspring 30 is gradually wound on the second reel 22 and a roll of the mainspring 30 is getting bigger, and eventually it will touch the pressing portion 44 of the stop device 40 before the shade is totally unfolded. The pressure of the pressing portion 44 of the stop device 40 on the mainspring 30 will give the mainspring 30 a resistance, and as the roll of the mainspring 30 on the second reel 22 getting bigger, the stop device 40 will be moved back a little bit to flex the rib board 19 and compress the spring 50 so that the pressure on the mainspring 30 is increasing accordingly. In other words, the resistance is increasing as the shade is approaching the total unfolded position. The resistance provided between the stop device 40 and mainspring 30 may restrict the mainspring 30 from going back to the first reel 20 because of its recovery force to make sure the shade stays at the totally unfolded position.

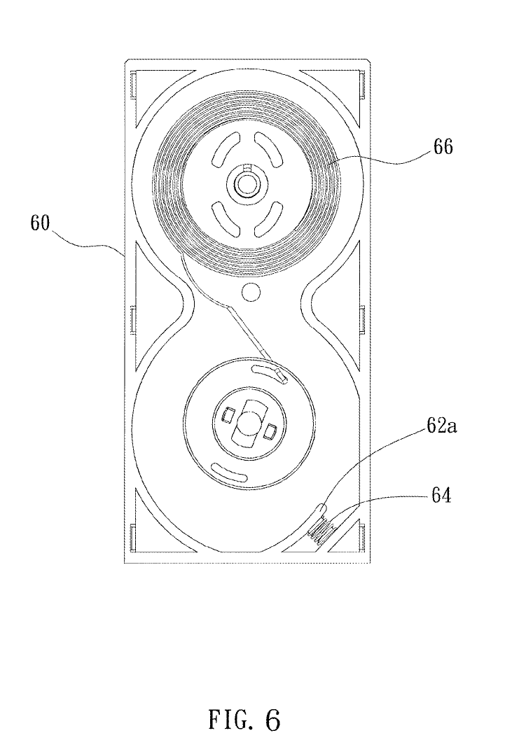

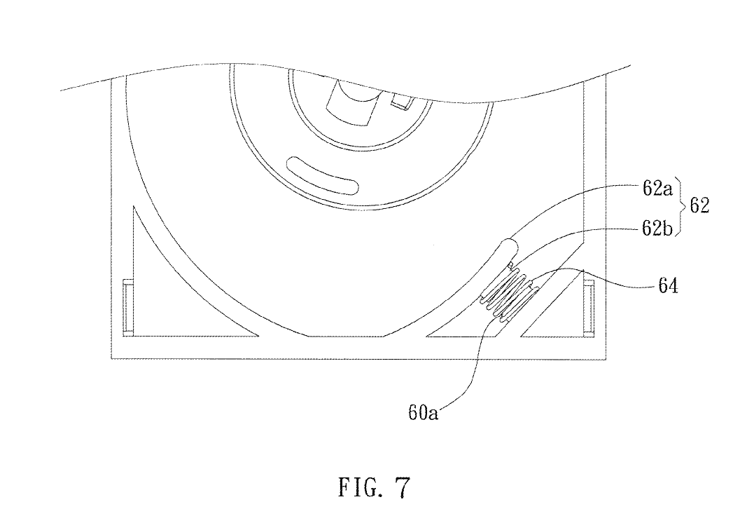

FIG. 6 and FIG. 7 show a spring brake of the third preferred embodiment, in which the stop device is a spring plate 62 projected from the base 60. In other words, the spring plate 62 has an end connected to the base 60 and a free distal end having the pressing portion 62a thereon. The spring plate 62 has post 62b on a side thereof, and the base 60 has a post 60a on a lateral wall. The driving device, which is a spring 64 as well, has its opposite ends to fit the posts 60a and 62b respectively. The same as above, the pressing portion 62a will press the mainspring 66 to give it a resistance while the shade approaches the totally unfolded position.

It is noted that the base may have various designs other than having two rooms as described above. It may have slots or lateral walls with different configurations.

The description above is only a few preferred embodiments of the present invention and the equivalence of the present invention is still in the scope of claim construction of the present invention.

What is claimed is:

1. A spring brake, comprising:
a base;
a first reel and a second reel respectively pivoted on the base;
a mainspring having opposite ends to connect to the first reel and the second reel; and
a stop device having a pressing portion to press the mainspring when the mainspring is wound on the second reel.

2. The spring brake as defined in claim 1, further comprising a driving device having opposite ends against the stop device and the base to urge the pressing portion of the stop device toward the second reel.

3. The spring brake as defined in claim 2, wherein the base has a bore on a lateral wall, the stop device has a rod to pass through the bore, the pressing portion is provided on an end of the rod, and a stop member is provided on the other end of the rod, and the driving device is a spring to be fitted to the rod and respectively urge the lateral wall of the base and the pressing portion.

4. The spring brake as defined in claim 3, wherein the stop member has a threaded hole, and the rod of the stop device has a threaded section so that the stop device is screwed into the threaded hole of the stop member to attach the stop member to an outer side of the lateral wall.

5. The spring brake as defined in claim 3, wherein the base is provided with a rib board, the rib board has a bore in association with the bore of the base, and the rod of the stop device passes through both the bores of the bores of the rib board and the base, and the pressing portion is beyond the rib board.

6. The spring brake as defined in claim 5, wherein the driving device is between the rib board and the base, and the rib board is flexible.

7. The spring brake as defined in claim 1, wherein the stop device is a spring plate projected from the base, and the pressing portion is on a free end thereof.

8. The spring brake as defined in claim 7, further comprising a driving device respectively against the spring plate and the base.

9. The spring brake as defined in claim 8, wherein the spring plate has a post, the base has a post on a lateral wall, and the driving device is a spring with opposite ends respectively fitted to the posts.
